(19) United States
(12) Patent Application Publication
(10) Pub. No.: US 2014/0188768 A1
(43) Pub. Date: Jul. 3, 2014

(54) System and Method For Creating Customized Model Ensembles On Demand

(71) Applicant: GENERAL ELECTRIC COMPANY, Schenectady, NY (US)

(72) Inventors: Piero Patrone Bonissone, Schenectady, NY (US); Neil Holger White Eklund, Schenectady, NY (US); Feng Xue, Clifton Park, NY (US); Naresh Sundaram Iyer, Saratoga Springs, NY (US); Weizhong Yan, Clifton Park, NY (US)

(73) Assignee: General Electric Company, Schenectady, NY (US)

(21) Appl. No.: 13/729,720

(22) Filed: Dec. 28, 2012

(51) Int. Cl. G06N 99/00

(52) U.S. Cl. 706/12

(57) ABSTRACT

A computer-implemented system for creating customized model ensembles on demand is provided. An input module is configured to receive a query. A selection module is configured to create a model ensemble by selecting a subset of models from a plurality of models, wherein selecting includes evaluating an aspect of applicability of the models with respect to answering the query. An application module is configured to apply the model ensemble to the query, thereby generating a set of individual results. A combination module is configured to combine the set of individual results into a combined result and output the combined result, wherein combining the set of individual results includes evaluating performance characteristics of the model ensemble relative to the query.

### BACKGROUND

The field of the invention relates generally to machine learning and, more particularly, to a system and method for creating customized model ensembles, or “collections of models”, on demand.

Machine learning is a branch of artificial intelligence concerned with the development of algorithms that evaluate empirical data, i.e., examples of real-world events, in order to make some type of future predictions related to those real-world events. A model is first “trained” on a set of training data. Once trained, the model is then used in an attempt to extract something more general about the training data's distribution, e.g., the model can produce predictions given a new situation.

At least some known approaches to machine learning utilize a data-driven modeling process which selects a data set for training, extracts a run-time model from the training data set, validates the model using a validation set, and applies the model to new queries. When a model deteriorates, a new model is created following a similar build cycle. This approach often focuses on the use of a single model for prediction, but exhibits both model deterioration problems as well as accuracy problems. A single model may provide good predictive performance for certain queries, but may perform poorly for many others.

To improve accuracy, at least some known approaches to machine learning implement model ensembles, i.e., collections of models, to obtain better predictive performance over any single model within the ensemble. A “bucket of models” approach selects the single best model from a group of models which would likely provide the best predictive results based on a given query. This approach will produce better results across many problems, but will never produce a better result than the best single model within the set. Other approaches combine the outputs of all models in an ensemble based on some weighting often based on the perceived appropriateness of each particular model to the query. Still other approaches use global estimates of model applicability for determining the amount of bias for which to compensate, and for individual model weighting. Further, models within the model ensemble are typically hand-chosen to participate in the ensemble, regardless of their potential performance with the particular query presented.

### BRIEF DESCRIPTION

In one aspect, a computer-implemented system for creating customized model ensembles on demand is provided. The system includes an input module configured to receive a query defining a feature space and having a query region within the feature space. The system also includes a selection module configured to create a model ensemble by selecting a subset of models from a plurality of models. Selecting the subset of models includes evaluating an aspect of applicability of at least one model of the plurality of models with respect to answering the query. The system further includes an application module configured to apply one or more models from the model ensemble to the query, thereby generating a set of individual results. The system also includes a combination module configured to combine the set of individual results into a combined result and output the combined result. Combining the set of individual results includes evaluating a performance characteristic of at least one model from the model ensemble relative to the query.

In a further aspect, one or more computer-readable storage media having computer-executable instructions embodied thereon are provided. When executed by at least one processor, the computer-executable instructions cause the at least one processor to receive a query defining a feature space and having a query region within the feature space. The computer-executable instructions also cause the at least one processor to create a model ensemble by selecting a subset of models from a plurality of models. Selecting the subset of models includes evaluating an aspect of applicability of at least one model of the plurality of models with respect to answering the query. The computer-executable instructions further cause the at least one processor to apply one or more models from the model ensemble to the query, thereby generating a set of individual results. The computer-executable instructions further cause the at least one processor to combine the set of individual results into a combined result. Combining the set of individual results includes evaluating a performance characteristic of at least one model from the model ensemble relative to the query and output the combined result.

In yet another aspect, a method for creating customized model ensembles on demand. The method is performed using a computer device coupled to a memory. The method includes receiving a query at the computer device. The query defines a feature space and having a query region within the feature space. The method also includes selecting a subset of models from a plurality of models including evaluating an aspect of applicability of at least one model of the plurality of models with respect to answering the query. Selecting a subset of models defines a model ensemble. The method further includes applying one or more models from the model ensemble to the query, thereby generating a set of individual results. The method also includes combining the set of individual results into a combined result. Combining includes evaluating a performance characteristic of at least one model from the model ensemble relative to the query. The method further includes outputting the combined result.

### BRIEF DESCRIPTION OF THE DRAWINGS

These and other features, aspects, and advantages will become better understood when the following detailed description is read with reference to the accompanying drawings in which like characters represent like parts throughout the drawings, wherein:

FIG. 1 is a block diagram of an exemplary computing device that may be used to create customized model ensembles on demand;

FIG. 2 is a block diagram of an exemplary system for creating customized model ensembles on demand using the computing device shown in FIG. 1,

FIG. 3 is a flow chart of an exemplary method of creating the customized model ensembles on demand using the computing device shown in FIG. 1,

FIG. 4 is a block diagram of a portion of the system shown in FIG. 2, illustrating the selection of applicable models, from the model database, for a given query;

FIG. 5 is a block diagram of a portion of the system shown in FIG. 2, illustrating the selection of the most locally dominant models from all of the applicable models selected in FIG. 4;

FIG. 6 is a block diagram of a portion of the system shown in FIG. 2, illustrating the final selection of the most diverse set of models from the locally dominant models selected in FIG. 5;

FIG. 7 is a block diagram of a portion of the system shown in FIG. 2, illustrating the application of the model ensemble, selected in FIGS. 4-6, to the query;

FIG. 8 is a block diagram of a portion of the system shown in FIG. 2, illustrating the combination of the individual results created by the application of the model ensemble to the query shown in FIG. 7;

FIG. 9 is a table of exemplary model metadata that may be used with the system for creating customized model ensembles on demand shown in FIG. 2;

FIG. 10 is a diagram of an exemplary Classification and Regression Tree (“CART Tree”) that may be used with the system for creating customized model ensembles on demand shown in FIG. 2;

FIG. 11 is a table of an exemplary dataset for the CART Tree shown in FIG. 10 when addressing a regression problem; and

FIG. 12 is a table of an exemplary dataset for the CART Tree shown in FIG. 10 when addressing a classification problem.

Unless otherwise indicated, the drawings provided herein are meant to illustrate key inventive features. These key inventive features are believed to be applicable in a wide variety of systems comprising one or more of the embodiments described herein. As such, the drawings are not meant to include all conventional features known by those of ordinary skill in the art to be required for practice.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “model” refers, generally, to an algorithm for solving a problem. The terms “model” and “algorithm” are used interchangeably herein. More specifically, in the context of Machine Learning and supervised learning, “model” refers to a dataset gathered from some real-world function, in which a set of input variables and their corresponding output variables are gathered. When properly configured, the model can act as a predictor for a problem if the model is near the problem's feature space. A model may be one of, without limitation, a one-class classifier, a multi-class classifier, or a predictor.

As used herein, the term “query” refers, generally, to the problem sought to be solved, or “predicted”, including any associated parameters that help define the problem. The terms “query” and “problem” are used interchangeably herein. In the context of Machine Learning, the problem to be solved is a value prediction for one or more “unknown” variables given a set of “known” variables. For “classification” problems, the answer to the query is a label, a prediction as to which class the query belongs. For “regression” problems, the answer to the “query” is a real value.

As used herein, the term “model ensemble” refers to a collection of models. In operation, model ensembles may be created in order to be applied to a given query. Models are generally included in an “ensemble” if they are, without limitation, in some way appropriate to answering queries in a given feature space, or in some way appropriate to answering the given query.

As used herein, the term “metadata” refers, generally, to data about data. In the context of Machine Learning, “metadata” refers to data about the algorithms or models used by the systems and methods described herein. The terms “metadata”, “meta-data”, and “meta-information” may be used interchangeably. Model metadata may include information about the model or the model's training set, such as, without limitation, the model's region of competence and applicability (based on its training set statistics), a summary of its (local) performance during validation, and an assessment of its remaining useful life (based on estimate of its obsolescence).

As used herein, the term “feature space” refers to a model, and, more specifically, to a model's “features”, or “attributes”. A model may be trained with data points having a number of variables n, each of which may be considered a “feature” of the model. Each data point may be represented with n variables, or n dimensions. These n dimensions create an abstract, n-dimensional space in which the model becomes trained. This n-dimensional space is referred to as the model's “feature space”. A query is defined by the intersection of features values, i.e., a query is a point in the “feature space”. A model is a mapping from the “feature space” to the output, i.e., the solution to the query.

As used herein, the term “query region” refers to a neighborhood around the point that characterizes the query. This region around the query in the query's feature space can be depicted by, without limitation, hyper-rectangles, hyper-spheres, and hyper-ellipsoids.

As used herein, the term “region of applicability” refers, generally, to an area within a model's feature space. More specifically, “region of applicability” refers to a region within the feature space in which the model is considered most accurate. For example, when a model is trained on a particular training dataset, the “region of applicability” will generally encompass much of the area which contains that training dataset, under the general assumption that a model is better able to predict within those areas in which it has been trained, i.e., near the training dataset points. With respect to a given query, models are considered more accurate for that query if the query falls within a “region of applicability” of the model.

As used herein, the term “hyper-rectangle” is a specific type of “region of applicability”. More specifically, in 2-dimensional space, a rectangle may be drawn around a set of points. For example, and without limitation, using a set of data points, a regression may define a line through a portion of 2-dimensional space, and a rectangle may be drawn around that line such that the sides of the rectangle are parallel to the line, and half the width of the rectangle away from the line, with a width such that most or all of the data points are included within the rectangle. In higher dimensions, the same rectangle may be drawn, but the rectangle may also include more than two dimensions. Further, the hyper-rectangle need not be parallel to axis, but rather may be oriented according to some correlation directions, such as by first performing a rotation of the axis along the principal components, and then defining the hyper-rectangle as parallel to this new coordinate system. Such a region is herein referred to as a “hyper-rectangle”.

As used herein, the term “global model” refers to a model which is trained on a broad set of data points within a feature space. As used herein, the term “local model” refers to a model which is trained on a narrower, more regional, localized set of data points within a region of a feature space. For example, and without limitation, a set of data points may exhibit multiple clusters of points, where the clusters seem to be separate from each other. A global model may be trained on all of the data points, regardless of the exhibited clustering, where a local model may be trained on just the data points within one of the clusters.

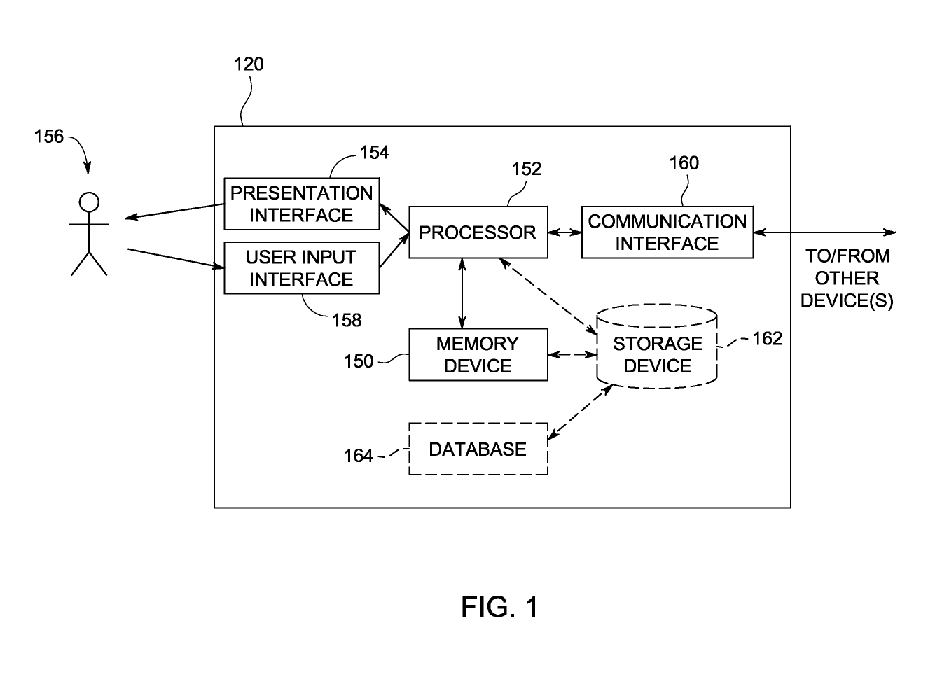

FIG. 1 is a block of an exemplary computing device 120 that may be used in a system to create customized model ensembles on demand. Alternatively, any computer architecture that enables operation of the systems and methods as described herein may be used. Computing device 120 facilitates, without limitation, computation, processing, analysis of models, receiving of queries, and storage of models.

Also, in the exemplary embodiment, computing device 120 includes a memory device 150 and a processor 152 operatively coupled to memory device 150 for executing instructions. In some embodiments, executable instructions are stored in memory device 150. Computing device 120 is configurable to perform one or more operations described herein by programming processor 152. For example, processor 152 may be programmed by encoding an operation as one or more executable instructions and providing the executable instructions in memory device 150. Processor 152 may include one or more processing units, e.g., without limitation, in a multi-core configuration.

Further, in the exemplary embodiment, memory device 150 is one or more devices that enable storage and retrieval of information such as executable instructions and/or other data. Memory device 150 may include one or more tangible, non-transitory computer-readable media, such as, without limitation, random access memory (RAM), dynamic random access memory (DRAM), static random access memory (SRAM), a solid state disk, a hard disk, read-only memory (ROM), erasable programmable ROM (EPROM), electrically erasable programmable ROM (EEPROM), and/or non-volatile RAM (NVRAM) memory. The above memory types are exemplary only, and are thus not limiting as to the types of memory usable for storage of a computer program.

Moreover, in some embodiments, computing device 120 includes a presentation interface 154 coupled to processor 152. Presentation interface 154 presents information, such as a user interface and/or an alarm, to a user 156. For example, presentation interface 154 may include a display adapter (not shown) that may be coupled to a display device (not shown), such as a cathode ray tube (CRT), a liquid crystal display (LCD), an organic LED (OLED) display, and/or a hand-held device with a display. In some embodiments, presentation interface 154 includes one or more display devices. In addition, or alternatively, presentation interface 154 may include an audio output device (not shown), e.g., an audio adapter and/or a speaker.

Also, in some embodiments, computing device 120 includes a user input interface 158. In the exemplary embodiment, user input interface 158 is coupled to processor 152 and receives input from user 156. User input interface 158 may include, for example, a keyboard, a pointing device, a mouse, a stylus, and/or a touch sensitive panel (e.g., a touch pad or a touch screen). A single component, such as a touch screen, may function as both a display device of presentation interface 154 and user input interface 158.

Further, a communication interface 160 is coupled to processor 152 and is configured to be coupled in communication with one or more other devices, such as, without limitation, the various modules included in system 200, another computing device 120, and any device capable of accessing computing device 120 including, without limitation, a portable laptop computer, a personal digital assistant (PDA), and a smart phone. Communication interface 160 may include, without limitation, a wired network adapter, a wireless network adapter, a mobile telecommunications adapter, a serial communication adapter, and/or a parallel communication adapter. Communication interface 160 may receive data from and/or transmit data to one or more remote devices. For example, a communication interface 160 of one computing device 120 may transmit transaction information to communication interface 160 of another computing device 120. Computing device 120 may be web-enabled for remote communications, for example, with a remote desktop computer (not shown).

Also, presentation interface 154 and/or communication interface 160 are both capable of providing information suitable for use with the methods described herein (e.g., to user 156 or another device). Accordingly, presentation interface 154 and communication interface 160 may be referred to as output devices. Similarly, user input interface 158 and communication interface 160 are capable of receiving information suitable for use with the methods described herein and may be referred to as input devices.

Further, processor 152 and/or memory device 150 may also be operatively coupled to a storage device 162. Storage device 162 is any computer-operated hardware suitable for storing and/or retrieving data, such as, but not limited to, data associated with a database 164. In the exemplary embodiment, storage device 162 is integrated in computing device 120. For example, computing device 120 may include one or more hard disk drives as storage device 162. Moreover, for example, storage device 162 may include multiple storage units such as hard disks and/or solid state disks in a redundant array of inexpensive disks (RAID) configuration. Storage device 162 may include a storage area network (SAN), a network attached storage (NAS) system, and/or cloud-based storage. Alternatively, storage device 162 is external to computing device 120 and may be accessed by a storage interface (not shown). Database 164 may contain a variety of models and metadata including, without limitation, local models, global models, and models from internal or external sources.

The embodiments illustrated and described herein as well as embodiments not specifically described herein but within the scope of aspects of the disclosure, constitute exemplary means for creating customized model ensembles on demand. For example, computing device 120, and any other similar computer device added thereto or included within, when integrated together, include sufficient computer-readable storage media that is/are programmed with sufficient computer-executable instructions to execute processes and techniques with a processor as described herein. Specifically, computing device 120 and any other similar computer device added thereto or included within, when integrated together, constitute an exemplary means for facilitating computation with the systems and methods described herein.

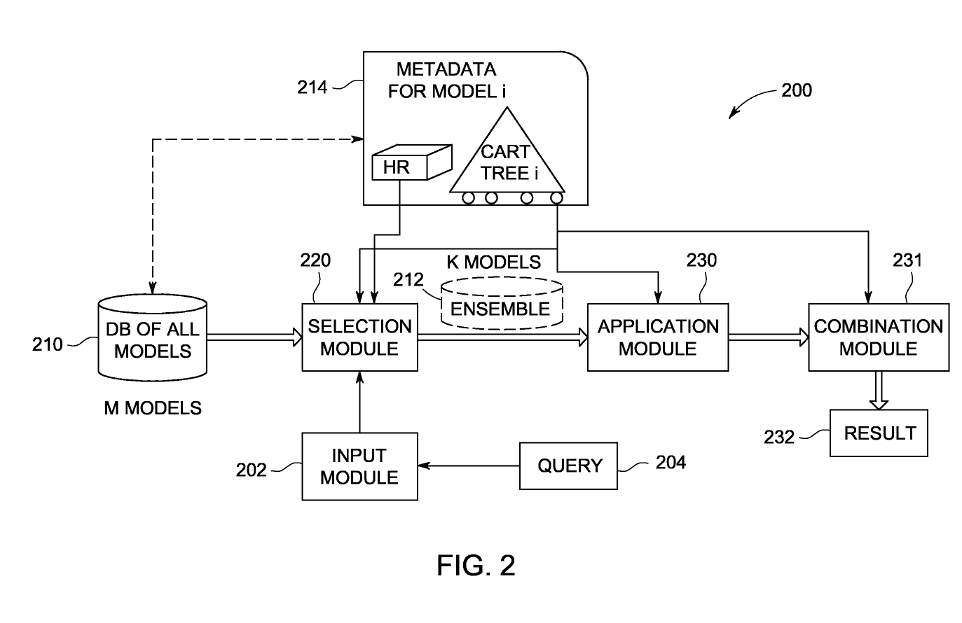

FIG. 2 is a block diagram of an exemplary system 200 for creating customized model ensembles on demand. System 200 includes at least one computing device 120 (shown in FIG. 1). For example, and without limitation, all parts of system 200 may be performed on one computing device 120, or across multiple computing devices 120 in communication with each other.

Also, in the exemplary embodiment, system 200 further includes an input module 202 which receives a query 204. Query 204 embodies a machine learning problem and includes at least one of, without limitation, a classification problem and a regression problem. In a classification problem, query 204 provides some known features of a given observation, and asks for a prediction as to which of a set of classes the observation belongs. In a regression problem, query 204 provides some known features of a given observation, and asks for a prediction as to a value of an unknown variable. In some embodiments, query 204 may be transmitted by a user 156 (shown in FIG. 1) using presentation interface 154 (shown in FIG. 1) and user input interface 158 (shown in FIG. 1). In operation, query 204 represents the real-world problem that system 200 must “solve”.

Also, in the exemplary embodiment, system 200 has a database of models 210 out of which a selection module 220 will build a model ensemble 212 customized to answer query 204. In the exemplary embodiment, database of models 210 has a number of models m between 100 and 1000. Alternatively, m may be any number of models that enable operation of the systems and methods as described herein. This database of models 210 represents all of the potential “tools” that system 200 may use to “solve” the problem.

Further, in the exemplary embodiment, system 200 also includes metadata 214 associated with each model in database of models 210. Database of models 210 and metadata 214 are stored in database 164 (shown in FIG. 1). Metadata 214 about each model will be used to select which “tools”, of all the m models, will be used to “solve” the problem.

Moreover, in the exemplary embodiment, a selection module 220 selects the best set of models to use in answering query 204. Selection module 220 creates model ensemble 212 by selecting k models from the m models in model database 210. The selection module 220 utilizes metadata 214 in the selection process, which is discussed in detail below. Model ensemble 212 is the set of “tools” selected for use in “solving” the problem.

Also, in the exemplary embodiment, an application module 230 will apply each of the k models in model ensemble 212 to query 204, thereby generating a set of individual results (not shown). Each individual result represents a single model's “answer” for the problem.

Further, in the exemplary embodiment, all of those k individual results are input into a combination module 231. Combination module 231 will weigh each of the k results during a combination process, described in detail below. Combination module 231 outputs a result 232, which represents the system's 200 single “answer” to the problem.

The selection process, the application process, and the combination process used by selection module 220, application module 230, and combination module 231, respectively, are discussed in detail below.

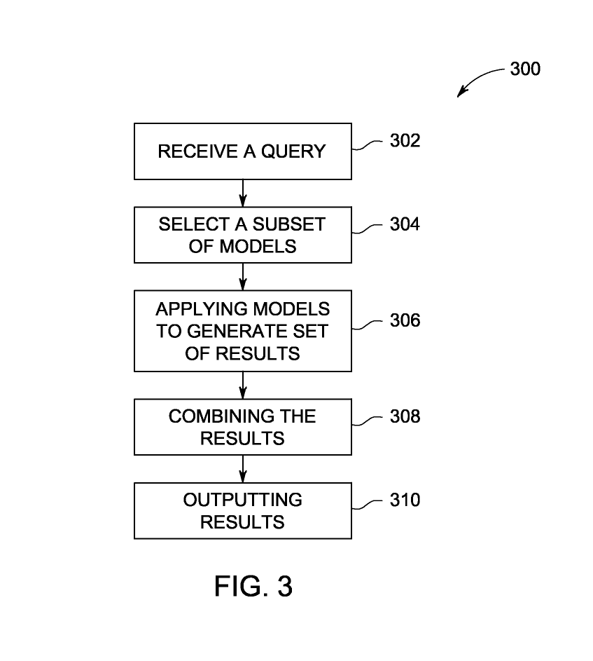

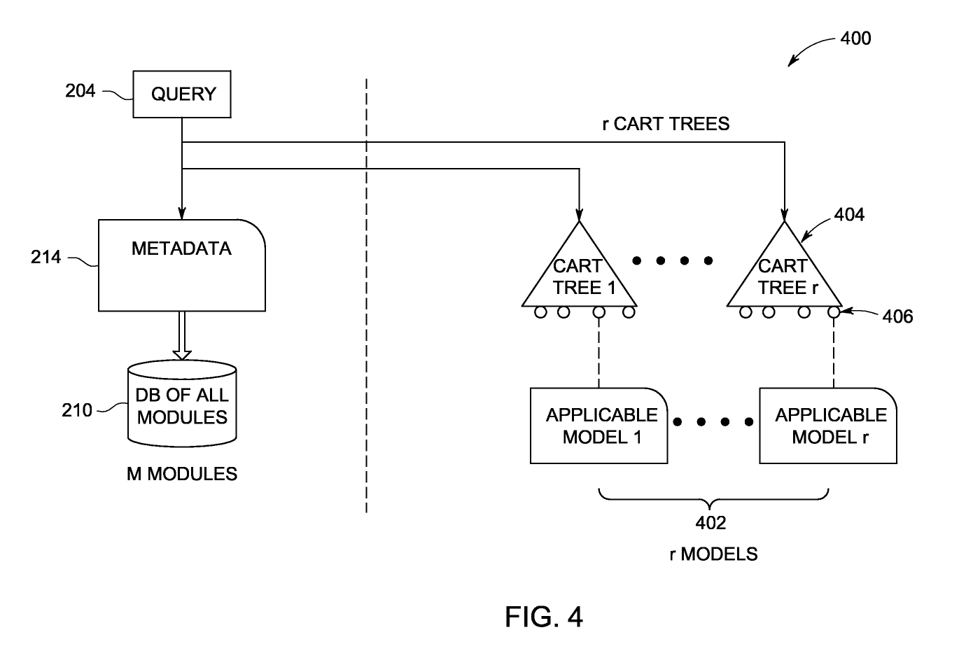

FIG. 3 is a flow chart of an exemplary method 300 of creating customized model ensembles 212 (shown in FIG. 2) on demand in order to answer query 204 (shown in FIG. 2). Query 204 is received 302 from user 156 (shown in FIG. 1). A subset of models, a model ensemble 212, is selected 304 from database of models 210 (shown in FIG. 2). In some embodiments, model ensemble 212 may be a subset of models selected 304 from database 164 (shown in FIG. 1). The process for selecting 304 the model ensemble 212 is diagrammed in FIGS. 4-6, and is discussed in detail below.

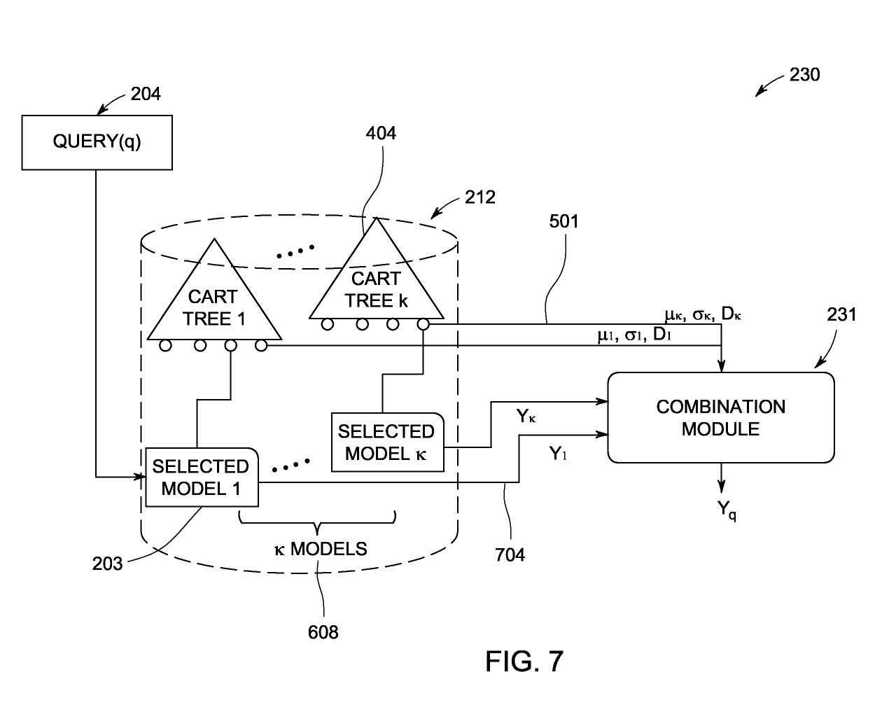

Further, in the exemplary embodiment, after selecting 304 the model ensemble 212, the model ensemble 212 is then applied 306 to query 204, generating a set of individual results. The process for selecting 304 the model ensemble 212 is diagrammed in FIG. 7, and is discussed in detail below.

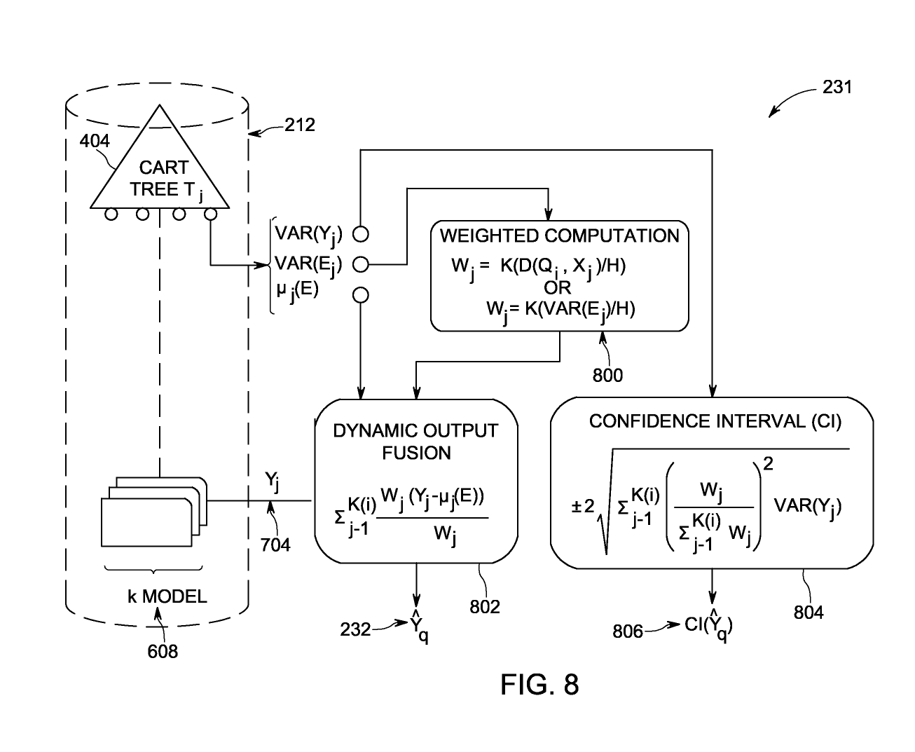

Moreover, in the exemplary embodiment, the individual results are combined 308 into result 232 (shown in FIG. 2). The combined 308 result 232 is then output 310. In some embodiments, result 232 may be output 310 to user 156 (shown in FIG. 1). The process for combining 308 the set of individual results is diagrammed in FIG. 8, and is discussed in detail below.

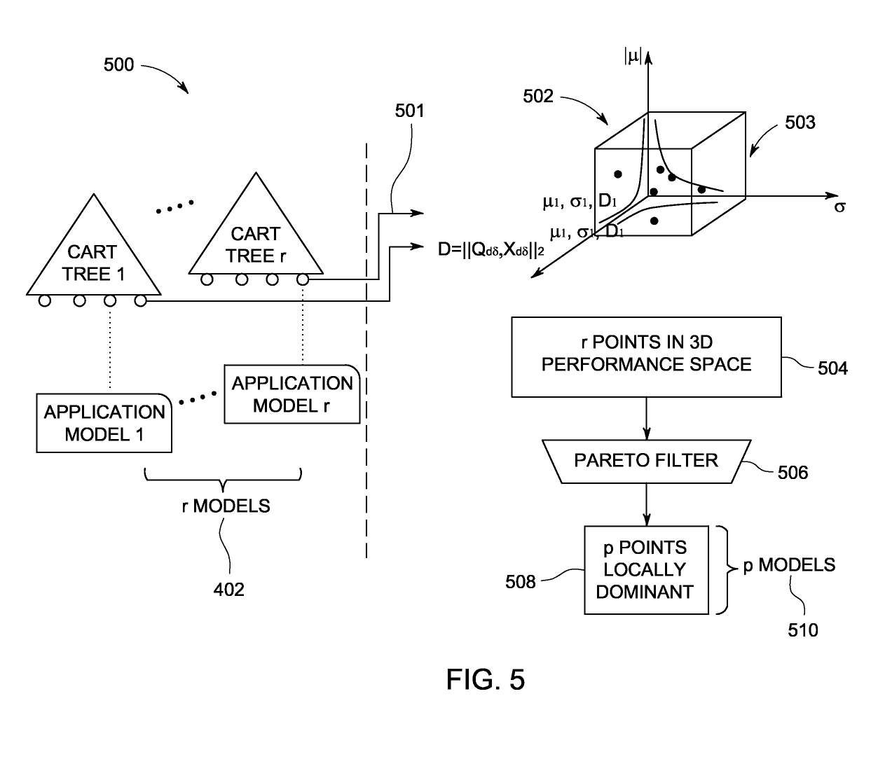

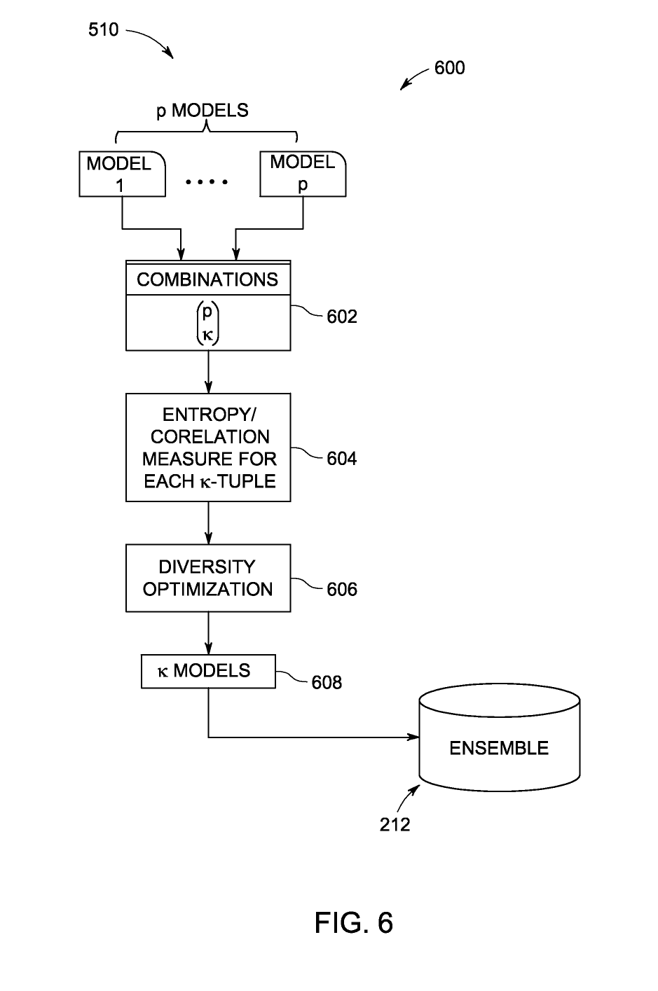

FIGS. 4-8 show exemplary steps for practicing system 200 (shown in FIG. 2) and method 300 (shown in FIG. 3). FIG. 4 illustrates the selection of applicable models from database of models 210 for a given query 204. FIG. 5 illustrates the selection of the most locally dominant models from all of the applicable models selected in FIG. 4. FIG. 6 illustrates the final selection of the most diverse set of models from the locally dominant models selected in FIG. 5, thereby generating model ensemble 212. FIG. 7 illustrates the application of model ensemble 212 to query 204. FIG. 8 illustrates the combination of the individual results created by the application of model ensemble 212 to query 204 shown in FIG. 7, thereby generating a single result.

FIGS. 4, 5, and 6 describe model selection 304 (shown in FIG. 3), operationally performed by selection module 220 (shown in FIG. 2). FIG. 7 describes applying 306 (shown in FIG. 3) the model ensemble 212 (shown in FIG. 2) to the query 204 (shown in FIG. 2) to generate a set of individual results (not shown), operationally performed by application module 230 (shown in FIG. 2). FIG. 8 describes combining 308 (shown in FIG. 3) the individual results to generate a combined result 232 (shown in FIG. 2), operationally performed by combination module 231 (shown in FIG. 2).

FIGS. 4-6 describe the exemplary process for selecting k models, i.e., model ensemble 212, from all of the m models in model database 210.

FIG. 4 is a block diagram of a portion 400 of an exemplary embodiment for selecting 304 (shown in FIG. 3) models for building model ensemble 212 (shown in FIG. 2). In the exemplary embodiment, database of models 210 includes multiple global models and local models appropriate for the feature space of query 204. In some embodiments, database of models 210 includes a library of diverse, robust local models for the feature space of query 204, with model diversity increased by using competing Machine Learning techniques trained on the same local regions. In some embodiments, database of models 210 may include models from such sources as, without limitation, crowdsourcing, outsourcing, meta-heuristics generation, legacy model repositories, and custom model creation.

Also, in the exemplary embodiment, the selection 304 process includes utilizing metadata 214 about the models in database of models 210. Metadata 214 about each model in database of models 210 is considered as to the model's relevance to answering query 204. Metadata 214 includes information about, without limitation, a model's region of competence and applicability (based on its training set statistics), a summary of a model's (local) performance during validation, and an assessment of a models remaining useful life (based on estimate of its obsolescence). In some embodiments, a model's relevance to answering query 204 may be determined by examining whether a query point of query 204 is contained within a region of applicability of the model. Further, in some embodiments, the region of applicability of the model may be a hyper-rectangle defined as the smallest hyper-rectangle that encloses all the training points in the training set of the model.

Further, in the exemplary embodiment, database of models 210 includes m models, of which r applicable models 402 are initially selected. In the exemplary embodiment, r has a value between 30 and 100. For a given query 204, model applicability is determined with a set of constraints, such as, without limitation, model soundness, i.e., are there sufficient points in the training/testing set to develop a reliable model competent in its region of applicability, model vitality, i.e., is the model up-to-date and not obsolete, and model applicability to the query, i.e., is the query in the model's competence region. Alternatively, a priori model source credibility, i.e., trusting some models more than others based on trust in the model's source, may also be used as a factor for model applicability.

Moreover, in the exemplary embodiment, each of the r applicable models 402 has associated with it a Classification and Regression Tree (“CART Tree”) 404, representing its local performance. In some embodiments, CART Tree 404 is metadata 214 associated with applicable model 402. In some embodiments, a copy of CART Tree 404 is read into memory device 150 (shown in FIG. 1), used only for the given query 204, and not altered or saved during or after method 300 (shown in FIG. 3) is complete. Alternatively, other types of probabilistic decision trees may be used. The structure and use of CART Trees is described in greater detail below.

FIG. 5 is a block diagram of a portion 500 of an exemplary embodiment for selecting 304 (shown in FIG. 3) models for building model ensemble 212 (shown in FIG. 2). In FIG. 4, the selection of r applicable models 402 from the m models in database of models 210 was shown. FIG. 5 depicts filtering the r applicable models 402 down to p models 510 based on local performance dominance, i.e., the p models most closely situated to answering the query. For example, and without limitation, in a minimization problem in which “less is better”, given two models A and B, A dominates B if A is at least as good as B along all the performance objectives, and there is at least one performance objective along which A is better than B:

Dominates(A,B) [symbol] ∀i(Aᵢ≦Bᵢ) [symbol] ∃j(Aᵢ<Bᵢ) (1)

In the example, the models selected are those not dominated in this performance objective, based on the model's local performance as obtained from the leaf nodes of the CART trees.

Also, in the exemplary embodiment, graph 502 depicts a 3-dimensional performance objective space 503 including a plot of points associated with the r applicable models 402. Each of the r applicable models 402 has associated performance estimation values 501 for bias |μ|, variability σ, and distance from the query D. Distance to the query D, represents the model's suitability to the query, i.e., distance of query Q to the origin X, computed in reduced, standardized features space. Graph 502 shows these points rendered in 3-dimensional performance space 503 corresponding to those same dimensions as performance estimation values 501, bias, variability, and distance from the query. Alternatively, other performance estimation values may be used.

Further, in the exemplary embodiment, all r points in 3D performance space 504 are then filtered with Pareto filter 506. In the 3-dimensional performance space 503, each of the three dimensions should be minimized Pareto filter 506 selects only a certain percentage of p locally dominant models 510 as represented by p points locally dominant 508 in 3-dimensional performance space 503. As used herein, the term “Pareto filter” means extracting from a set of points all the points which are non-dominated, as explained above. In some embodiments, a second tier Pareto set can be used after removing the first tier, i.e., applying the Pareto filter again to extract the next set of non-dominated points after removing the first set. This may be done if, after obtaining the first set of Pareto-best points, not enough points were found and more points were needed. In the exemplary embodiment, p has a value in a range between 10 and 30. Alternatively, p may have any value that enables operation of the systems and methods as described herein.

FIG. 6 is a block diagram of a portion 600 of an exemplary embodiment for selecting 304 (shown in FIG. 3) step for building model ensemble 212 (shown in FIG. 2). In FIG. 5, the filtering of r applicable models 402 down to p locally dominant models 510 was shown. FIG. 6 depicts the final selection 600 of k models 608 from p models 510.

Also, in the exemplary embodiment, final selection 600 further refines the model set for model diversity by exploring the error correlation among smaller possible subsets of models 602. Final selection 600 uses a greedy search 604 with an examination of diversity for subsets of models 602. In the exemplary embodiment, diversity of the k classifiers is determined using Entropy Measure E, described below. Alternatively, any other method of measuring diversity in classifiers and predictors that enables operation of the systems and methods as described herein may be used. One assumption is that each of the k models had a common data set on which it was evaluated. Greedy search 604 will create an N by k matrix M, such that N is the number of records evaluated by k models.

Further, in one embodiment, when the models are classifiers, cell M[i,j] contains the binary value Z[I,j] (1 if classifier j classified record i correctly, 0 otherwise). This metric assumes that each classifier decision on the training/validation records has already been obtained, by applying the argmax function to the probability density function (PDF) generated by the classifier. Diversity of the k classifiers is computed using Entropy Measure E, where E takes values in [0,1]:

$$E = \frac{1}{N} {\sum }_{i = 1}^{N} [ \frac{1}{k - floor ( \frac{k + 1}{2} )} min ( {\sum }_{j = 1}^{k} M [ i , j ] , k - {\sum }_{j = 1}^{k} M [ i , j ] ) ] \qquad ( 2 )$$

Moreover, in another embodiment, when the models are predictors, cell M[i,j] contains the error value e[i,j], which is the prediction error made by model i on record j. The process to follow will be to histogram of record error, normalized histogram of record error, normalized record entropy, and overall normalized entropy. Compute a histogram of the errors for each record M[i,j], by defining a reasonable bin size for the histogram, thus defining the total number of bins, nmax. Let H(i,r) be the histogram for record i, where r defines the bin number (r=1, nmax). Normalize histogram H(i,r), so that its area is equal to one (becoming a PDF). Let H_{N}(i,r) be the normalized histogram, i.e.:

$${H}_{N} ( i , r ) = \frac{H ( i , r )}{{\sum }_{r = 1}^{nmax} H ( i , r )} \qquad ( 3 )$$

Compute the normalized record entropy of the PDF (so that its value is in [0,1]), i.e.:

$$ent ( i ) = - ( \frac{1}{ln nmax} ) {\sum }_{r = 1}^{nmax} {H}_{N} ( i , r ) \times ln {H}_{N} ( i , r ) \qquad ( 4 )$$

where (1/ln nmax) is a normalizing factor so that ent(i) takes values in [0,1]:

$${H}_{N} ( i , r ) = \frac{H ( i , r )}{{\sum }_{r = 1}^{nmax} H ( i , r )} \qquad ( 5 )$$

Average the normalized entropy over all N records:

$$E = \frac{1}{N} {\sum }_{i}^{N} ent ( i ) \qquad ( 6 )$$

E takes values in [0,1]. For both classifiers and prediction problems, higher overall normalized entropy values indicate higher models diversity.

Also, in the exemplary embodiment, possible subsets of models 602 includes all possible k-tuples chosen from p models to evaluate their correlation. In the preferred embodiment, final selection 600 uses greedy search 604 to reduce the computational complexity of searching all possible k-tuples chosen from p models. Greedy search 604 starts with k=2, and computes the normalized entropy for each 2-tuple to determine the one(s) with highest entropy. Greedy search 604 then increases to k=3 to explore all 3-tuples. If the maximum normalized entropy for the explored 3-tuples is lower than the maximum value obtained for the 2-tuples, greedy search 604 stops and uses the 2-tuple with the highest entropy. Otherwise, greedy search 604 will keep the 3-tuple with the highest entropy and explore the next level (k=4) and so on, until no further improvement can be found. In the worst case, complexity will be:

$$\begin{matrix}\# comb = ( \begin{matrix}p \\ 2\end{matrix} ) + {\sum }_{j = 3}^{p} ( p - j ) \\ = \frac{p ( p - 1 )}{2} + \frac{( p - 1 ) ( p - 2 )}{2} \\ = \frac{{p}^{2} - p + {p}^{2} - 3 p + 2}{2} \\ = {p}^{2} - 2 p + 1 \\ = {( p - 1 )}^{2}\end{matrix} \qquad ( 7 )$$

This represents a drastic reduction in complexity with respect to the original combinatorial number

$$( \begin{matrix}p \\ k\end{matrix} ) .$$

In other embodiments, an even more drastic reduction would be to skip this step. For situations in which there is a small number of models p in the pre-selection step, all p models may be used, and this step may be skipped.

Further, in the exemplary embodiment, final selection 600 reduces the p locally dominant models 510 down to k models 608 with diversity optimization 606 after greedy search 604. Diversity optimization 606 selects only the k models 608 with the most uncorrelated errors. Models in an ensemble should be sufficiently different from each other for the ensemble's output to be better than the individual models outputs. The goal is to use an ensemble whose elements have the most uncorrelated errors. After final selection 600, k models 608 are assembled as model ensemble 212 for answering query 204 (shown in FIG. 2). Final selection 600 represents the completion of selecting 304 a subset of models, as shown in FIG. 3, and culminates in the completion of model ensemble 212.

FIG. 7 is a block diagram showing an exemplary embodiment of applying 306 (shown in FIG. 3) each model 703 of model ensemble 212, k models, to query 204. Each model 703 is applied 306 to query 204, and generates an individual result 704. Those individual results 704 are passed to combination module 231, along with each model's performance estimation values 501. Individual results 704 will be weighted and combined into a single result using the process discussed below.

FIG. 8 is a block diagram showing an exemplary embodiment of combining 308 individual results 704 to produce a single result 232. For a regression problem, fusion may be accomplished using, without limitation, bias compensation and/or other weighting schemes based on variance, distance, or both. In the exemplary embodiment, bias compensation is used to weight 800 each individual result 704 when combined 802 to form individual result 704, where h is a smoothing factor for the kernel function K( ).

$${\hat{y}}_{{q}_{i}} = \frac{{\sum }_{j = 1}^{k ( i )} {W}_{j} ( {y}_{j} - {μ}_{j} ( e ) )}{{\sum }_{j = 1}^{k ( i )} {W}_{j}} \qquad ( 8 )$$

where

$${W}_{j} = K ( \frac{Var ( {e}_{j} )}{h} ) .$$

Alternatively or additionally, distance may be used to weight 800 each individual result 704, i.e.,

$${W}_{j} = K ( \frac{d ( {q}_{i} , {X}_{j} )}{h} ) .$$

Use of CART Trees 404 minimized the sum of the variances across all leaf nodes of CART Tree 404. In other embodiments, combination module 231 will verify if this bias compensation will suffice or if further weighing of the outcomes of selected modules is required. If so, the following Lazy Learning weighing scheme may be used, in which the weight is the kernel function K(.) evaluated in the (standardized) distance d between the query q and the centroid X_{ds} the points in the leaf node Lₛ(q), i.e.:

$$\hat{y} ( q ) = \frac{{\sum }_{s = 1}^{k} {w}_{s} ( {y}_{s} - {μ}_{s} ( q ) )}{{\sum }_{s = 1}^{k} {w}_{s}} \qquad ( 9 )$$

where

$${w}_{s} = K ( \frac{d ( q , {X}_{ds} )}{h} ) ,$$

and h is the usual smoothing factor for the kernel function K(.) obtained by minimizing the validation error.

Also, in one exemplary embodiment, for a classification problem, a similar bias compensation may be performed. For the case when all k models are equally weighted:

$$\hat{y} ( q ) = argmax \{ \frac{1}{k} {\sum }_{j = 1}^{k ( i )} ( {y}_{j} - {μ}_{j} ( q ) ) \} \qquad ( 10 )$$

Should weights be assigned to the k models, following the Lazy Learning weighting scheme, similar to the above-described method:

$${\hat{y}}_{{q}_{i}} = argmax \{ {\sum }_{j = 1}^{k ( i )} {W}_{j} ( {y}_{j} - {μ}_{j} ( e ) ) / {\sum }_{j = 1}^{k ( i )} {W}_{j} \} \qquad ( 11 )$$

where

$${W}_{j} = K ( \frac{d ( {q}_{i} , {X}_{j} )}{h} ) .$$

Further, in the exemplary embodiment, uncertainty bounds, in the form of a confidence interval 806, are attached to the output of model ensemble 212. Confidence interval calculation 804 uses the statistics of each model in model ensemble 212 based on its performance on the test set:

$$CI ( {\hat{y}}_{{q}_{i}} ) = \pm 2 \sqrt{{\sum }_{j = 1}^{k ( i )} {( \frac{{W}_{j}}{{\sum }_{j = 1}^{k ( i )} {W}_{j}} )}^{2} Var ( {y}_{j} )} \qquad ( 12 )$$

Moreover, in the exemplary embodiment, after combining 308 individual results 704 to produce a single result 232, and calculating 804 a confidence interval 806 for the single result 232, combination module 231 outputs result 232. In some embodiments, the confidence interval 806 is also returned.

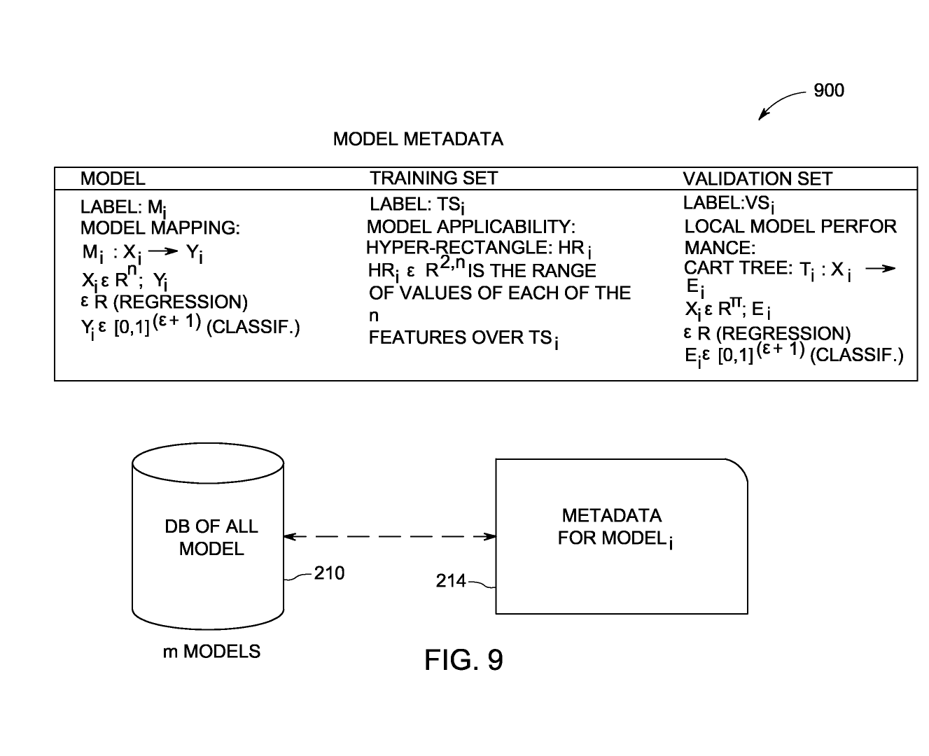

FIG. 9 is a table of exemplary model metadata 900 that may be used with the system 200 (shown in FIG. 2) for creating customized model ensembles on demand. In operation, each prediction or classification problem will have m total models available.

For Prediction Problems—each regression model Mᵢ will define a mapping:

Mᵢ:X→Y, where i=1, . . . , m;|X|=n;|Y|=1;Xε [symbol] ⁿ;Yε

[symbol]

In a more general case, for prediction of multiple variables, i.e., g variables:

Mᵢ:X→Y, where i=1, . . . , m;|X|=n;|Y|=g;Xε [symbol] ⁿ;Yε [symbol] ^{g}

For Classification Problems—each classification model Mᵢ will define a mapping:

Mᵢ:X→Y, where i=1, . . . , m;|X|=n;|Y|=(C+1)

where C is the number of classes. In one embodiment, the classifier output is a probability density function (PDF) over C classes. The first C components of the PDF are the probabilities of the corresponding classes. The (C+1)^{th} element of the PDF allows the classifier to represent the choice “none of the above” (i.e., it permits to deal with the Open World Assumption). The (C+1)^{th} element of the PDF is computed as the complement to 1 of the sum of the first C components. The final decision of classifier Mᵢ is the argmax of the PDF.

Also, in the exemplary embodiment, metadata 214 for each model Mᵢ is contained in database of models 210. Metadata includes, without limitation, information that can be used to reason about the model's applicability and model's suitability of a model for a given query.

Further, in some embodiments, metadata 214 regarding a model's region of applicability may be defined by a Hyper-rectangle in the model's feature space. Each model Mᵢ has a training set, TSᵢ, which is a region of the feature space X The Hyper-rectangle of model Mᵢ, HR(Mᵢ), may be defined as the smallest hyper-rectangle that encloses all the training points in the training set TSᵢ. If a query point q is contained in HR(Mᵢ), then the model Mᵢ may be considered applicable to the query q. For a set of query points Q, the model Mᵢ may be considered applicable if HR(Q) is not disjoint with HR(Mᵢ). In other embodiments, a model's region of applicability may be a shape other than rectangular, such as, without limitation, ovoid, elliptical, and spherical.

Moreover, in some embodiments, a model's local performance in a regression problem may use, without limitation, continuous case-based reasoning and fuzzy constraints, and lazy learning to estimate the local prediction error. The run-time use of lazy learning may be replaced with the compilation of local performance via CART trees, for the purpose of correcting the prediction via bias compensation. A model's local performance in a classification problem, a similar lazy learning approach to estimate the local classification error may be used. Alternatively, other probabilistic decision trees, such as, without limitation, probabilistic trees that use minimization of absolute error, or minimization of entropy, that enables operation of the systems and methods described herein may be used.

Also, in some embodiments, metadata 214 may include, without limitation, temporal and usage information, such as model creation date, last usage date, and usage frequencies, which may be used by the model lifecycle management to select the models to maintain and update. Further, in some embodiments, model performance metadata may be maintained. Model performance may include model usefulness, i.e., high selection frequency, accuracy, i.e., high relevance weight, and requiring an update to avoid obsolescence.

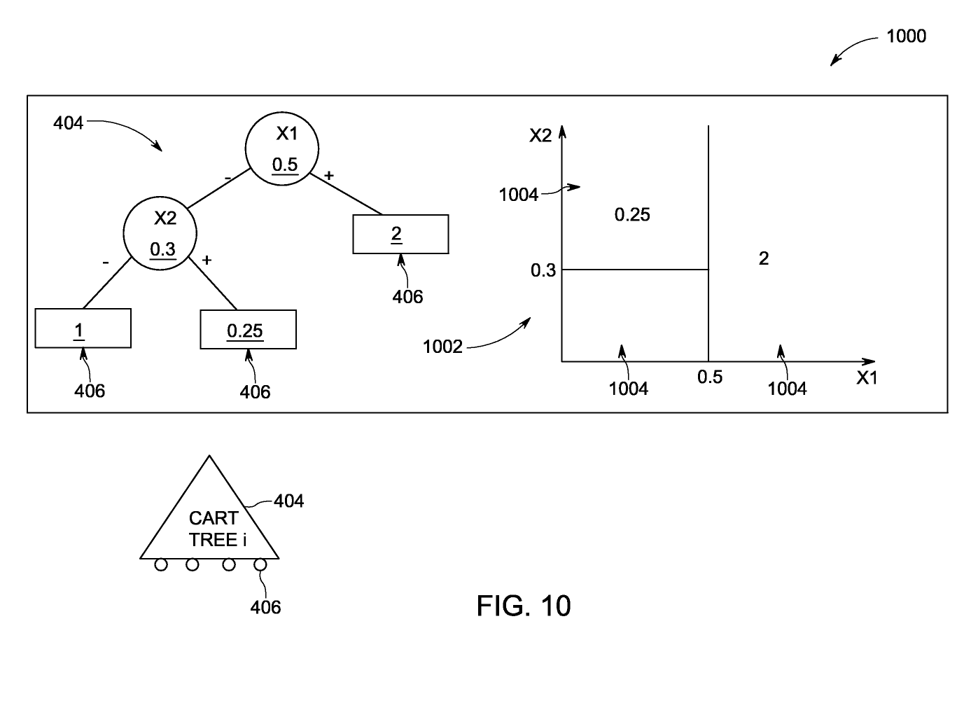

FIG. 10 is a diagram 1000 of an exemplary CART Tree 404 that may be used with the system 200 (shown in FIG. 2) for creating customized model ensembles on demand. Each model (not separately shown) in database of models 210 (shown in FIG. 2) has a CART Tree 404 associated with the model. The model has associated with it a feature space 1002. The CART Tree 404 describes and compiles the local performance of its model in different regions 1004 of feature space 1002. Regions 1004 are defined by a set of hyper-planes, constraints on selected features that are on the path from the root node to each leaf node. In CART Tree 404, the regions 1004 are represented as leaf nodes 406, clusters of similar values for the classification or regression target variable. CART Tree 404 is of depth d, and trained on a model error vector obtained during the training/testing of the model.

Also, in the exemplary embodiment, each leaf node 406 in CART Tree 404 will be defined by its path to the root of the tree and will contain d constraints over (at most) d features. Each leaf node 406 includes a pointer to a table containing the leaf node estimates of the model's performance in the query region, including, without limitation: number of points in the leaf Nᵢ (from the training/testing set); bias μ(e)ᵢ (average error computed over Nᵢ points); error standard deviation computed over the Nᵢ points σ(e)ᵢ; standardized centroid of the Nᵢ points in the leaf (in reduced dimensional space dᵢ) X_{d}_{ᵢ}; and output standard deviation computed over the Nᵢ points σ(y)ᵢ. Number of points in the leaf is used to verify that there are enough points in the leaf node to have statistical validity, which may be done by establishing a pruning rule in CART. Bias, error standard deviation, and standardized centroid will be used to map the model to a 3-dimensional performance space (not shown in FIG. 4) during the model pre-selection step. Output standard deviation is used to compute 804 (shown in FIG. 8) the confidence interval of the output.

Further, in the exemplary embodiment, CART Trees and probabilistic decision trees are models themselves, i.e., they define a mapping from inputs to outputs. The inputs for these “meta-models” are the same features in the feature space of the models themselves, i.e., the inputs for the models, the correct outputs for the points in the training set used to train the models, and the outputs of the models. The outputs of these meta-models are the variables that best represent the performance of the models, such as, without limitation, signed error, percentage error, absolute value of error, squared error, absolute scaled error, and absolute percentage error. In the exemplary embodiment, the signed error e is defined as the difference between the model output yᵢ(q), indicating the output of model i to query q, and the correct output for query q as indicated in the training set.

Further, in the exemplary embodiment, the local performance of each model is summarized by CART Tree 404 Tᵢ, which maps feature space 1002 to the signed error, eᵢ, i.e., Tᵢ:X→eᵢ, where eᵢ is the difference between the scalar output yᵢ and the corresponding target tᵢ. Each CART Tree 404 will have depth dᵢ such that there will be up to 2^{d}^{ᵢ} paths from the root to the leaf nodes, for a fully balanced tree. For each CART Tree 404, the path from the root node to each leaf node is stored. The path is a conjunct of constraint rules that need to be satisfied to reach the leaf node. Only a subset of the n features of X would be used by CART Tree 404 across all paths. Any single path will use at most dᵢ features. For each selected leaf, distances from the query to the centroid of the points are computed in the reduced feature space. Alternatively, relative signed error may be used, i.e., the percentage of the signed error rather than its value.

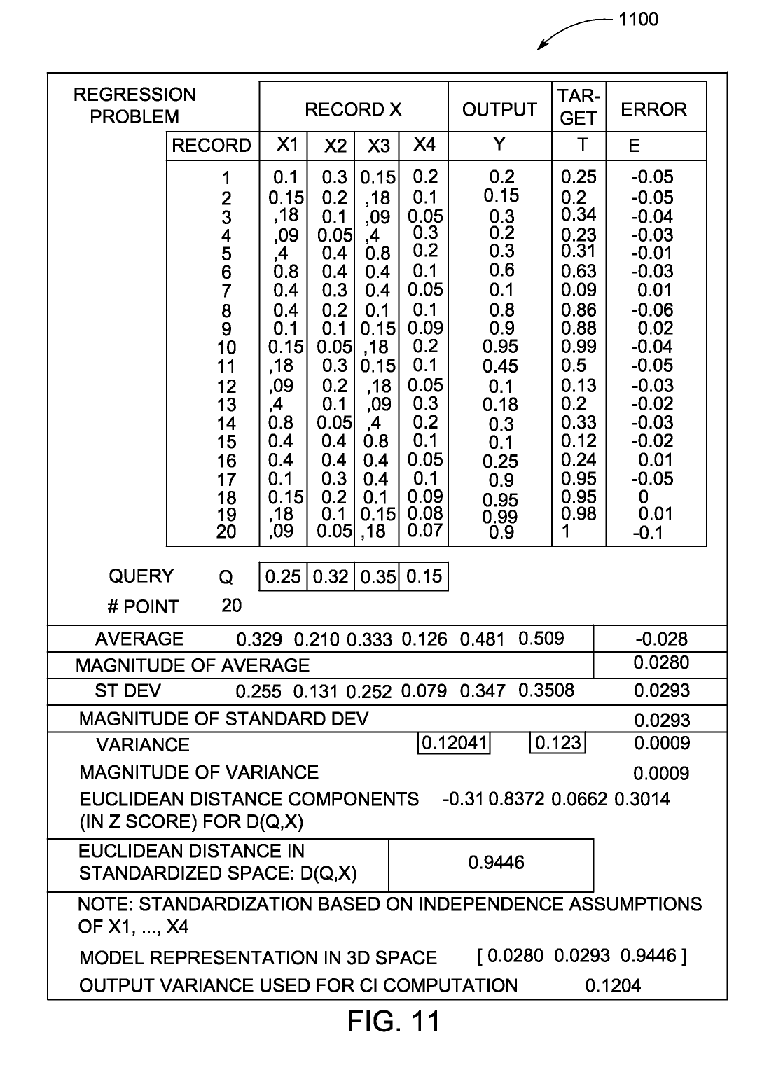

FIG. 11 is a table of an exemplary dataset 1100 for leaf node 406 of CART Tree 404 (shown in FIG. 10) when addressing a regression problem. Each leaf node 406 will of CART Tree 404 for a model (not shown) used in addressing a regression problem will have a dataset similar to dataset 1100.

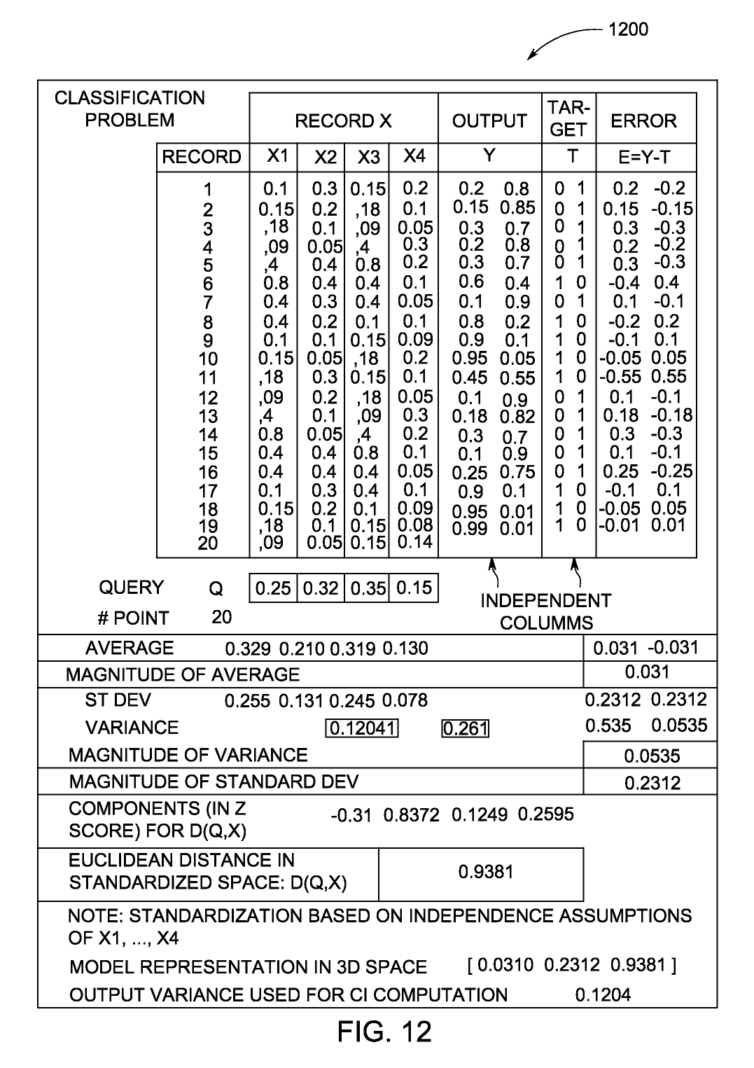

FIG. 12 is a table of an exemplary dataset 1200 for leaf node 406 of CART Tree 404 (shown in FIG. 10) when addressing a 1-class classification problem. Each leaf node 406 will of CART Tree 404 for a model (not shown) used in addressing a 1-class classification problem will have a dataset similar to dataset 1100.

The above-described systems and methods provide a way to create customize model ensembles on demand. The embodiments described herein allow for selecting a customized set of models from a database of models. The database of models also includes metadata about the models. The metadata relating to the models includes information clarifying appropriateness of each particular model to a given query such that, at the time of the query, each model's applicability may be weighed against that exact query. Models are selected based on the query, i.e., local models within the query's feature space are used in order to increase the accuracy of each model's predictions. The individual results of each model within the model ensemble are combined, creating an aggregate result from multiple models rather than relying on the best single model. Metadata regarding each model's applicability to the particular query is again used during the combination of the individual results, both in determining the amount of bias for which to compensate, as well as in weighing each individual model's result, i.e., based on that particular model's individual applicability to the query.

An exemplary technical effect of the methods, systems, and apparatus described herein includes at least one of: (a) customizing the particular set of models within a model ensemble based on a specific query; (b) automating model ensemble creation; (c) facilitating a database-oriented approach to model ensemble creation; and (d) combining individual model results in such a way as to consider each individual model's accuracy to the query relative to the other models in the ensemble.

Exemplary embodiments of systems and methods for creating customized model ensembles on demand are described above in detail. The systems and methods described herein are not limited to the specific embodiments described herein, but rather, components of systems and/or steps of the methods may be utilized independently and separately from other components and/or steps described herein. For example, the methods may also be used in combination with other systems requiring concept extraction systems and methods, and are not limited to practice with only the text processing system and concept extraction system and methods as described herein. Rather, the exemplary embodiments can be implemented and utilized in connection with many other concept extraction applications.

Although specific features of various embodiments may be shown in some drawings and not in others, this is for convenience only. In accordance with the principles of the systems and methods described herein, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented system for creating customized model ensembles on demand, said system comprising:
an input module configured to receive a query defining a feature space and having a query region within the feature space;
a selection module configured to create a model ensemble by selecting a subset of models from a plurality of models, wherein selecting the subset of models includes evaluating an aspect of applicability of at least one model of the plurality of models with respect to answering the query;
an application module configured to apply one or more models from the model ensemble to the query, thereby generating a set of individual results; and
a combination module configured to combine the set of individual results into a combined result and output the combined result, wherein combining the set of individual results includes evaluating a performance characteristic of at least one model from the model ensemble relative to the query.

2. A system in accordance with claim 1, wherein the selection module is further configured to select a local model from the plurality of models, the local model defining a region of applicability within the feature space.

3. A system in accordance with claim 2, wherein the selection module is further configured to evaluate at least one of the feature space, the query region, and the region of applicability within the feature space.

4. A system in accordance with claim 1, wherein the selection module is further configured to evaluate metadata about the at least one model of the plurality of models.

5. A system in accordance with claim 4, wherein the selection module is further configured to evaluate a probabilistic decision tree for the at least one model of the plurality of models.

6. A system in accordance with claim 1, wherein the combination module is further configured to generate and apply a dynamic weight for each of the individual results.

7. One or more computer-readable storage media having computer-executable instructions embodied thereon, wherein when executed by at least one processor, the computer-executable instructions cause the processor to:
receive a query defining a feature space and having a query region within the feature space;
create a model ensemble by selecting a subset of models from a plurality of models, wherein selecting the subset of models includes evaluating an aspect of applicability of at least one model of the plurality of models with respect to answering the query;
apply one or more models from the model ensemble to the query, thereby generating a set of individual results;
combine the set of individual results into a combined result, wherein combining the set of individual results includes evaluating a performance characteristic of at least one model from the model ensemble relative to the query; and
output the combined result.

8. The computer-readable storage media in accordance with claim 7, wherein the computer-executable instructions further cause the processor to select a local model from the plurality of models, the local model defining a region of applicability within the feature space.

9. The computer-readable storage media in accordance with claim 8, wherein the computer-executable instructions further cause the processor to evaluate at least one of the feature space, the query region, and the region of applicability within the feature space.

10. The computer-readable storage media in accordance with claim 7, wherein the computer-executable instructions further cause the processor to evaluate metadata about the at least one model of the plurality of models.

11. The computer-readable storage media in accordance with claim 10, wherein the computer-executable instructions further cause the processor to evaluate a probabilistic decision tree for the at least one model.

12. The computer-readable storage media in accordance with claim 7, wherein evaluating a performance characteristic includes performing dynamic bias compensation.

13. The computer-readable storage media in accordance with claim 7, wherein the computer-executable instructions further cause the processor to generate and apply a dynamic weight for each of the individual results.

14. A method for creating customized model ensembles on demand, the method is performed using a computer device coupled to a memory, said method comprising:
receiving a query at the computer device, the query defining a feature space and having a query region within the feature space;
selecting a subset of models from a plurality of models including evaluating an aspect of applicability of at least one model of the plurality of models with respect to answering the query, said selecting a subset of models defining a model ensemble;
applying one or more models from the model ensemble to the query, thereby generating a set of individual results;
combining the set of individual results into a combined result, said combining including evaluating a performance characteristic of at least one model from the model ensemble relative to the query; and
outputting the combined result.

15. A method in accordance with claim 14, wherein selecting a subset of models further includes selecting a local model from the plurality of models, the local model defining a region of applicability within the feature space.

16. A method in accordance with claim 15, wherein selecting a subset of models further includes evaluating one of the feature space, the query region, and the region of applicability within the feature space.

17. A method in accordance with claim 14, wherein selecting a subset of models further includes evaluating metadata about the at least one model of the plurality of models.

18. A method in accordance with claim 17, wherein selecting a subset of models further includes evaluating a probabilistic decision tree for the at least one model of the plurality of models.

19. A method in accordance with claim 14, wherein combining the set of individual results further includes performing dynamic bias compensation.

20. A method in accordance with claim 14, wherein combining the set of individual results further includes generating and applying a dynamic weight for each of the individual results in the set of individual results.
